(19) United States
(12) Patent Application Publication
(10) Pub. No.: US 2025/0347164 A1
(43) Pub. Date: Nov. 13, 2025

(54) DOOR CLOSING RESTRICTION DEVICE AND DOOR DEVICE OF VEHICLE

(71) Applicant: ALPHA CORPORATION, Yokohama-shi (JP)

(72) Inventor: Soh SAITO, Yokohama-shi (JP)

(73) Assignee: ALPHA CORPORATION, Yokohama-shi (JP)

(21) Appl. No.: 19/205,745

(22) Filed: May 12, 2025

(30) Foreign Application Priority Data
May 13, 2024 (JP) 2024-077910

(51) Int. Cl. E05F 5/02; B60J 10/76

(52) U.S. Cl. CPC E05F 5/025; B60J 10/76; E05Y 2900/531

(57) ABSTRACT

A door closing restriction device for restricting closing of a door of a vehicle, which is provided on the door, the door closing restriction device includes a stopper provided on a door edge portion of the door and configured to be moveable between a storage position where the stopper is stored inside the door and a protruding position where the stopper protrudes from the door edge portion, an operation unit provided on the door, and a transmission unit configured to transmit an operation force of the operation unit to the stopper. The stopper moves to the protruding position by operating the operation unit.

### CROSS-REFERENCE TO RELATED APPLICATIONS

This application is based on and claims priority under 35 USC 119 from Japanese Patent Application No. 2024-077910 filed on May 13, 2024, the entire content of which is incorporated herein by reference.

### TECHNICAL FIELD

The present disclosure relates to a door closing restriction device for a vehicle and a door device of a vehicle.

### BACKGROUND ART

In the related art, in a vehicle including a sashless door, a weather strip is attached to a peripheral edge of an opening of the door, and when a door glass is in a closed state, an upper edge of the door glass is enveloped by the weather strip, so that a waterproof effect and a soundproofing effect can be obtained as disclosed in, for example, JP2004-82808A.

In such a vehicle, when the door glass is closed in a fully closed position, the door glass may come into contact with the weather strip and the door glass may be damaged. Therefore, in such a vehicle, a door control device, which controls raising and lowering of the door glass, performs slight lowering control for slightly lowering the door glass from the fully closed position when the door is opened and closed to prevent the door glass from coming into contact with the weather strip.

In recent years, a vehicle in which the door control device electronically controls an entire door is also known. The door control device may not operate due to update of a program, interruption of power supply from a vehicle power supply due to some circumstances, or the like. When a user wants to open and close the door in such a situation, the user can open the door using an emergency unlocking unit such as a cylinder outside the vehicle or an emergency inside handle inside the vehicle. However, since opening and closing control for the door glass is also stopped when the door control device is not in operation, the slight lowering control for the door glass is not executed, and the door is opened and closed while the door glass is in a fully closed state. Since the door glass is attached to the door in a posture in which a tip is inclined toward the weather strip from a posture orthogonal to a door opening and closing direction, the weather strip is elastically deformed when the door is opened, so that the door glass passes through the weather strip and the door can be opened, but when the door is closed, an end edge of the door glass abuts against the weather strip in a compression direction, so that there is a possibility that the door glass cannot pass through the weather strip and is damaged.

An object of the present disclosure is to provide a door closing restriction device that can protect a door glass even in a situation in which a door control device is not in operation and a door device of a vehicle.

### SUMMARY OF INVENTION

The present disclosure includes the following configurations.

A door closing restriction device for restricting closing of a door of a vehicle, which is provided on the door, the door closing restriction device includes a stopper provided on a door edge portion of the door and configured to be moveable between a storage position where the stopper is stored inside the door and a protruding position where the stopper protrudes from the door edge portion, an operation unit provided on the door, and a transmission unit configured to transmit an operation force of the operation unit to the stopper. The stopper moves to the protruding position by operating the operation unit.

According to the present disclosure, it is possible to provide a door closing restriction device that can protect a door glass even in a situation in which a door control device is not in operation and a door device of a vehicle.

### BRIEF DESCRIPTION OF DRAWINGS

FIG. 1 is a perspective view of a door including a door closing restriction device according to the present embodiment;

FIG. 2 is a schematic configuration diagram of the door including the door closing restriction device according to the present embodiment as viewed from the inside;

FIG. 3 is a schematic cross-sectional view taken along a horizontal direction of a door edge portion in a state in which a stopper is stored;

FIG. 4 is a schematic cross-sectional view taken along the horizontal direction of the door edge portion in a state in which the stopper protrudes;

FIG. 5 is a schematic configuration diagram of an operation unit and a transmission unit forming the door closing restriction device;

FIG. 6 is a perspective view of the operation unit and the transmission unit forming the door closing restriction device;

FIG. 7 is a schematic configuration diagram of a cam mechanism;

FIG. 8 is a schematic configuration diagram for illustrating movement of the cam mechanism;

FIG. 9 is a schematic configuration diagram for illustrating movement of the cam mechanism;

FIG. 10 is a schematic configuration diagram for illustrating movement of the cam mechanism;

FIG. 11 is a schematic configuration diagram for illustrating movement of the cam mechanism; and

FIG. 12 is a schematic configuration diagram of a door including a door closing restriction device according to another embodiment as viewed from the outside.

### DESCRIPTION OF EMBODIMENTS

Hereinafter, embodiments of the present disclosure will be described with reference to the drawings. In the following drawings, an arrow FR indicates a vehicle front side, an arrow BC indicates a vehicle rear side, an arrow UP indicates a vehicle upper side, an arrow DW indicates a vehicle lower side, an arrow WR indicates a vehicle right side, and an arrow WL indicates a vehicle left side.

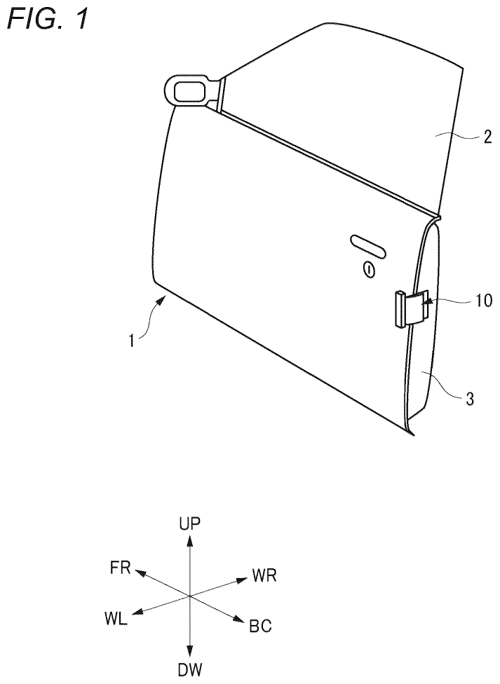

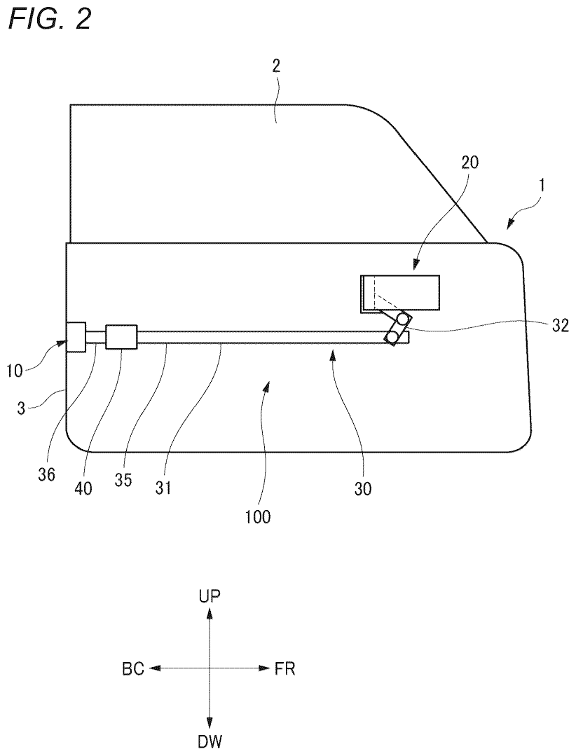

FIG. 1 is a perspective view of a door 1 including a door closing restriction device 100 according to the present embodiment. FIG. 2 is a schematic configuration diagram of the door 1 including the door closing restriction device 100 according to the present embodiment as viewed from the inside.

As illustrated in FIGS. 1 and 2, the door closing restriction device 100 according to the present embodiment is provided on the door 1 of a vehicle. The door closing restriction device 100 includes a stopper 10, an operation unit 20, and a transmission unit 30. The door 1 further includes a door lock device (not illustrated) that holds a door in a closed posture, a raising and lowering device (not illustrated) that raises and lowers the door glass 2, a door control unit (not illustrated) that controls the door lock device and the raising and lowering device, a door switch (not illustrated) that performs a door opening operation of the door 1, and a detection unit (not illustrated) that detects an opened state and a closed state of the door 1, and door 1 forms a door device.

The door 1 on which the door closing restriction device 100 is provided is coupled to the vehicle at a side in the vehicle front side FR, and is rotatable with respect to the vehicle at this coupling portion. An opening of the vehicle is opened and closed by rotating the door 1 at the coupling portion. The door 1 is, for example, a sashless door having no window frame, and in a closed state, a peripheral edge of the door glass 2 that is provided to be capable of being raised and lowered on the door 1 is enveloped by a weather strip provided on an opening peripheral edge of the vehicle.

In such a vehicle, when a user operates the door switch to open the door 1, the door control unit controls the raising and lowering device to lower the door glass 2, thereby releasing fitting between the door glass 2 and the weather strip. The door control unit controls the door lock device to release a door closed state, thereby opening the door. When the detection unit detects that the door is displaced from the opened state to the closed state, the door control unit drives the raising and lowering device to fit the door glass 2 into the weather strip.

The stopper 10 of the door closing restriction device 100 is provided on a door edge portion 3 on a side opposite to a side of the door 1 coupled to the vehicle. The stopper 10 is made of, for example, an elastic material, and is provided to be retractable on the door edge portion 3. A door closing restriction device may be configured as a door opening and closing control device such as a door check.

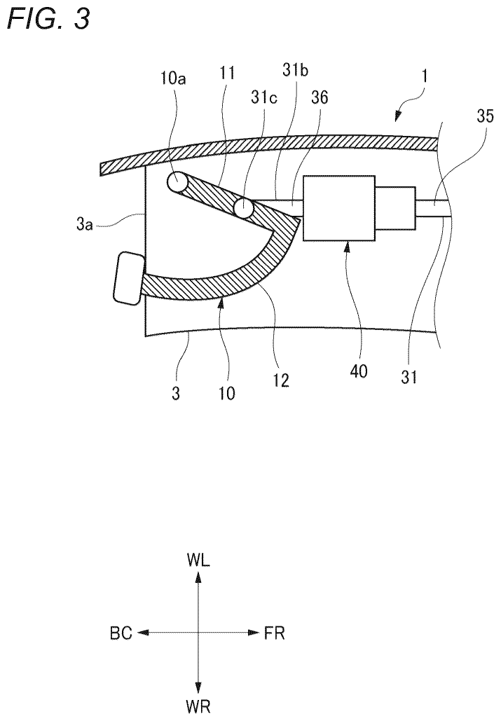

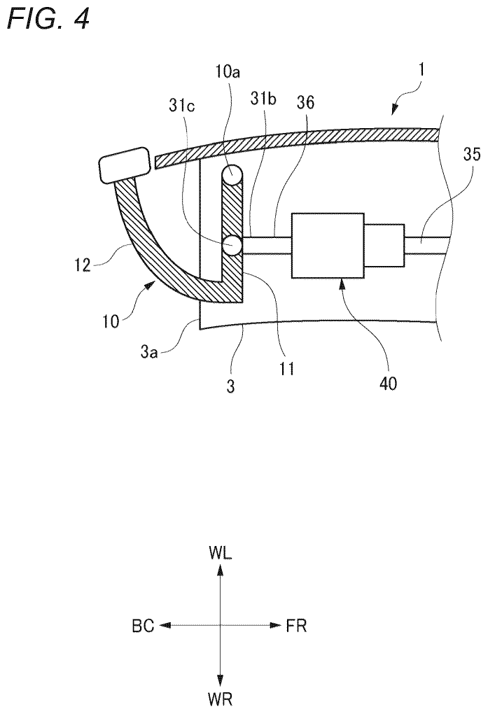

FIG. 3 is a schematic cross-sectional view taken along a horizontal direction of the door edge portion 3 in a state in which the stopper 10 is stored. FIG. 4 is a schematic cross-sectional view taken along the horizontal direction of the door edge portion 3 in a state in which the stopper 10 protrudes.

As illustrated in FIGS. 3 and 4, the stopper 10 includes a coupling portion 11 and a restricting portion 12. The stopper 10 is formed in a substantially U-shape in a plan view in which the restricting portion 12 is connected to the coupling portion 11. An end portion of the coupling portion 11 of the stopper 10 is rotatably supported by a support shaft 10a about an axis in an upper-lower direction with respect to the door 1. By being rotated with respect to the door 1, the stopper 10 is located at a storage position (position in FIG. 3) inside the door 1 and a protruding position (position in FIG. 4) where the restricting portion 12 protrudes from an end surface 3a of the door edge portion 3. In the present embodiment, a case in which the stopper 10 is provided to be retractable on the door edge portion 3 on the side opposite to the side of the door 1 coupled to the vehicle is described, but the stopper 10 may be retractable on the door edge portion 3 on a lower end side, for example.

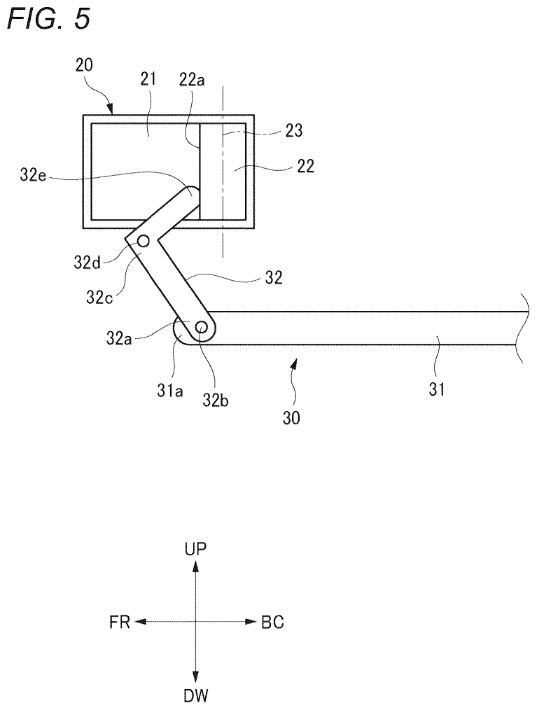

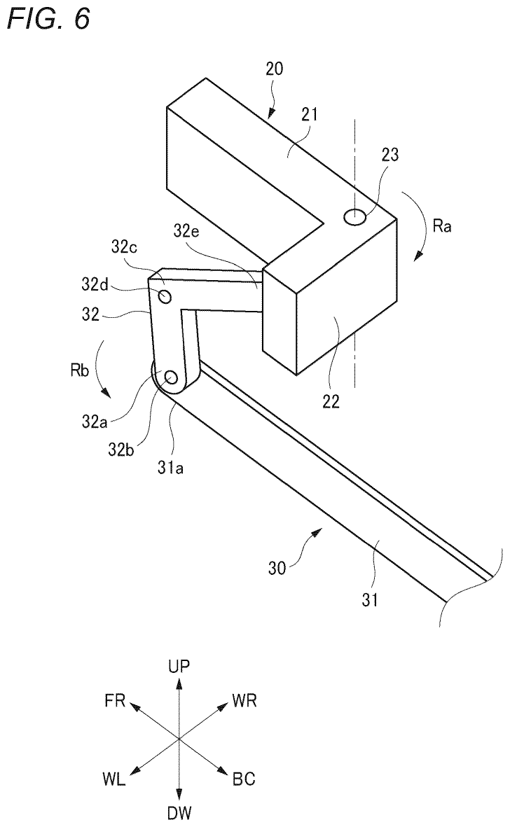

FIG. 5 is a schematic configuration diagram of the operation unit 20 and the transmission unit 30 forming the door closing restriction device 100. FIG. 6 is a perspective view of the operation unit 20 and the transmission unit 30 forming the door closing restriction device 100.

As illustrated in FIGS. 5 and 6, the operation unit 20 includes a gripping portion 21 and an action portion 22. The action portion 22 extends laterally from an end portion of the gripping portion 21, whereby the operation unit 20 is formed in an L-shape in a plan view. The operation unit 20 has a rotation shaft 23 at a portion where the gripping portion 21 and the action portion 22 are connected, and is rotatably supported by the rotation shaft 23 about an axis in the upper-lower direction with respect to the door 1. The gripping portion 21 of the operation unit 20 is exposed to the inside of the door 1, and the user grips the gripping portion 21 of the operation unit 20 and rotates the operation unit 20 in a rotation direction Ra. In this way, the operation unit 20 can be operated from the inside of the door 1. Although not illustrated, the operation unit 20 is coupled to the door lock device by a wire or the like, and functions as an emergency door handle that can release a latch of the door lock device as the user rotates the operation unit 20 in the rotation direction Ra.

The transmission unit 30 includes a rod 31 and a link 32. The rod 31 is formed in an elongated rod shape, and is disposed along a vehicle front-rear direction. The rod 31 is movably supported along a longitudinal direction. One end 32a of the link 32 is coupled to one end 31a of the rod 31 by a pin 32b. The link 32 is formed in an L-shape bent at an intermediate portion, and a bent portion 32c of the link 32 is rotatably supported by a pin 32d about an axis in a vehicle width direction. The other end 32e of the link 32 is in contact with a side surface 22a of the action portion 22 on a gripping portion 21 side of the operation unit 20. The other end 31b of the rod 31 is coupled to the coupling portion 11 of the stopper 10 by a pin 31c (see FIGS. 3 and 4). The transmission unit 30 includes a cam mechanism 40 near the other end 31b of the rod 31. The rod 31 is divided into an operation-side rod 35 on an operation unit 20 side and a stopper-side rod 36 on a stopper 10 side, and the cam mechanism 40 is provided between the operation-side rod 35 and the stopper-side rod 36 (see FIGS. 2 to 4).

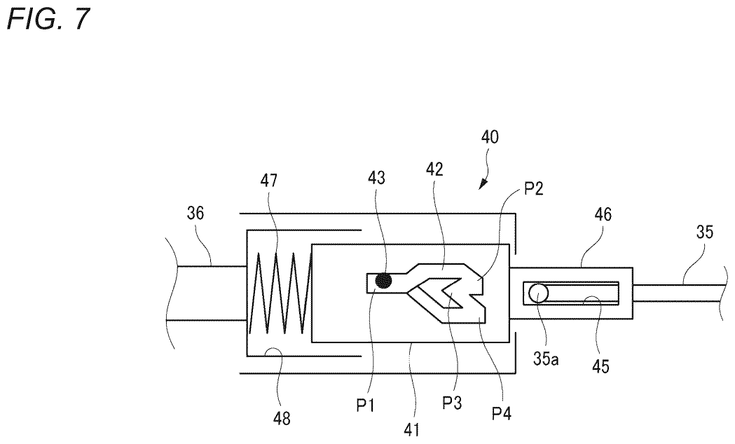

FIG. 7 is a schematic configuration diagram of the cam mechanism 40.

As illustrated in FIG. 7, the cam mechanism 40 includes a heart cam 41. The heart cam 41 includes a cam groove 42 and a cam pin 43. The cam groove 42 includes a heart-shaped groove portion, and the cam pin 43 is movable with respect to the cam groove 42. In the heart cam 41, the operation-side rod 35 is coupled to one end side, and the stopper-side rod 36 is coupled to the other end side. One end of the heart cam 41, to which the operation-side rod 35 is coupled, is provided with a coupling portion 46 having a long hole 45, and a coupling end 35a of the operation-side rod 35 is movable within a range of the long hole 45. The other end of the heart cam 41, to which the stopper-side rod 36 is coupled, is provided with a recessed portion 48 in which a coil spring 47 is accommodated.

The cam groove 42 of the heart cam 41 has a waiting position P1, a first pushing position P2, a holding position P3, and a second pushing position P4. In the heart cam 41, the waiting position P1 is located at the other end side to which the stopper-side rod 36 is coupled, and the first pushing position P2 and the second pushing position P4 are located at the one end side to which the operation-side rod 35 is coupled. In the heart cam 41, the holding position P3 is located between the first pushing position P2 and the second pushing position P4, and is located closer to the waiting position P1 than the first pushing position P2 and the second pushing position P4.

In the door 1 including the door closing restriction device 100 having the above-described structure, when the user operates the operation unit 20 in the opened state, the stopper 10 at the storage position inside the door 1 is rotated to the protruding position where the restricting portion 12 protrudes from the end surface 3a of the door edge portion 3. Then, even when the door 1 is to be closed in this state, the restricting portion 12 of the stopper 10 interferes with a door frame of the vehicle such as a pillar, and the door closing is restricted. Accordingly, even when the door glass 2 of the door 1 is in a closed state, interference of the door glass 2 with the weather strip is avoided, and the door glass 2 is protected. In the door closing restriction device 100, when the user operates the operation unit 20 again, the stopper 10 located at the protruding position is retracted into the door 1 and located at the storage position. Accordingly, the restriction on closing the door 1 is released, and the door 1 can be closed.

Next, a specific operation of the door closing restriction device 100 when the user operates the operation unit 20 will be described.

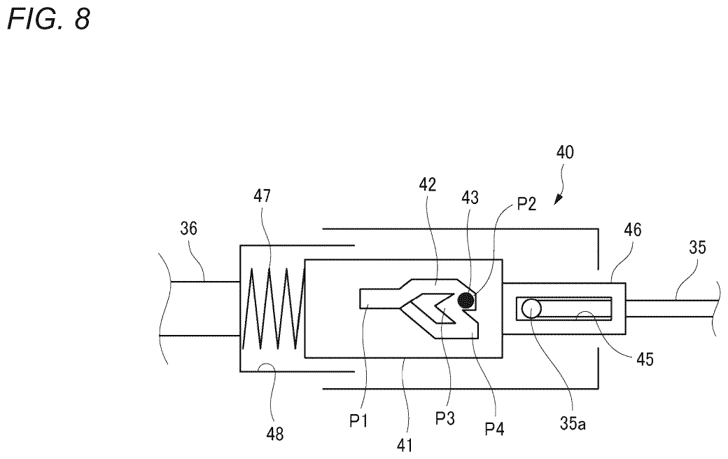

FIGS. 8 to 11 are each a schematic configuration diagram illustrating movement of the cam mechanism 40.

### (At the Time of Door Closing Restriction Operation)

The user grips the gripping portion 21 of the operation unit 20 and rotates the operation unit 20 in the rotation direction Ra (see FIG. 6). Then, the door lock device is operated via a wire (not illustrated) to release door holding, the link 32 of the transmission unit 30 is rotated in the rotation direction Rb by the action portion 22 of the operation unit 20 (see FIG. 6), and the rod 31 of the transmission unit 30 coupled to the link 32 moves toward the vehicle rear side BC toward the stopper 10. Accordingly, the stopper 10 at the storage position is rotated to the protruding position where the restricting portion 12 of the stopper 10 protrudes from the end surface 3a of the door edge portion 3, so that the door 1 is brought into a door closing restricted state (see FIG. 4). As illustrated in FIG. 8, in the cam mechanism 40, the heart cam 41 is pushed out by the coupling end 35a of the operation-side rod 35, and the cam pin 43 located at the waiting position P1 moves to the first pushing position P2.

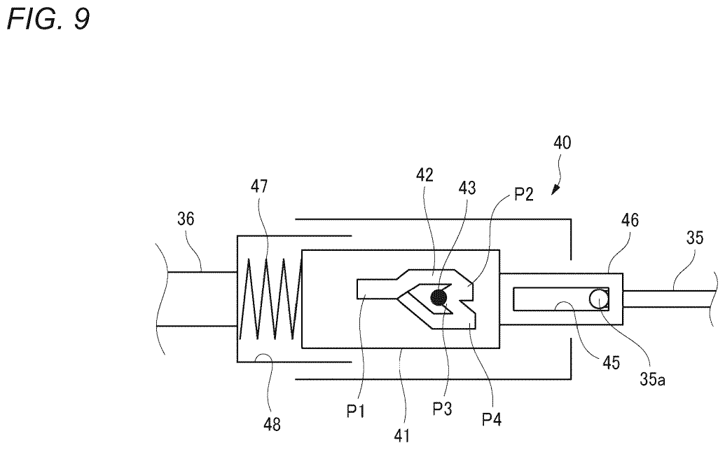

In this state, when the user releases the grip for the gripping portion 21 of the operation unit 20, the pushing of the heart cam 41 performed by the coupling end 35a of the operation-side rod 35 is released, and as illustrated in FIG. 9, the cam pin 43 moves to the holding position P3 and is held. Accordingly, the heart cam 41 is held in a state of being pushed out toward the stopper 10. Therefore, the stopper 10 is maintained in a state of being located at the protruding position where the restricting portion 12 protrudes from the end surface 3a of door edge portion 3, and is maintained in the door closing restricted state in which closing of the door 1 is restricted.

### (At the Time of Door Closing Regulation Release Operation)

In a state in which the door 1 is opened, the user grips the gripping portion 21 of the operation unit 20 and rotates the operation unit 20 in the rotation direction Ra (see FIG. 6). Then, the link 32 of the transmission unit 30 is rotated in the rotation direction Rb by the action portion 22 of the operation unit 20 (see FIG. 6), and the rod 31 of the transmission unit 30 coupled to the link 32 moves toward the vehicle rear side BC toward the stopper 10.

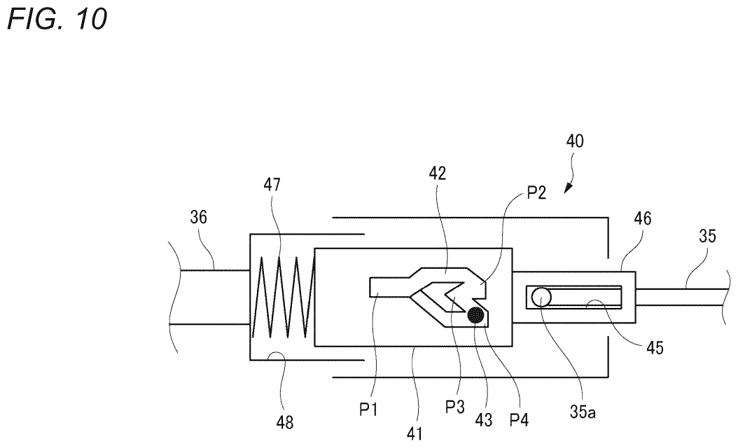

Then, as illustrated in FIG. 10, in the cam mechanism 40, the heart cam 41 is pushed out again by the coupling end 35a of the operation-side rod 35, and the cam pin 43 located at the holding position P3 moves to the second pushing position P4.

In this state, when the user releases the grip for the gripping portion 21 of the operation unit 20, the pushing of the heart cam 41 performed by the coupling end 35a of the operation-side rod 35 is released, and the cam pin 43 moves to the waiting position P1 (see FIG. 7). Accordingly, the heart cam 41 is retracted into a side opposite to the stopper 10 side. Therefore, the stopper 10 at the protruding position is rotated to the storage position inside the door 1, and the door closing restricted state of the door 1 using the stopper 10 is released.

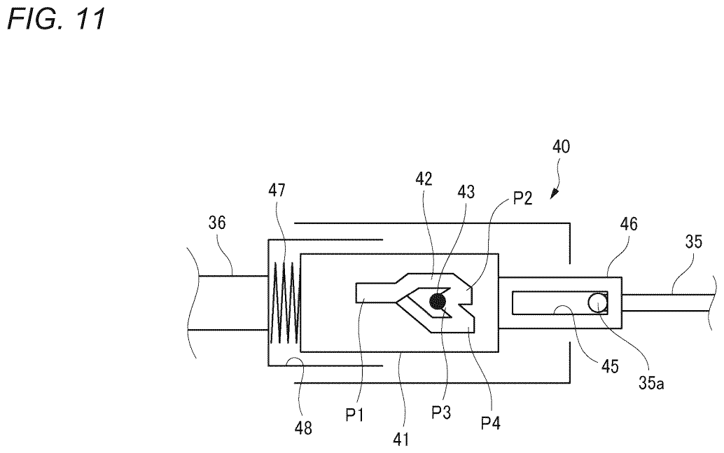

Even when the holding performed by the door lock device is released by operating the operation unit 20, the door 1 may not rotate in an opening direction, and the door closing restriction operation may be performed in a state in which the door 1 is closed. Thus, even when the user grips the gripping portion 21 of the operation unit 20 and rotates the operation unit 20 in the rotation direction Ra in the state in which the door 1 is closed, in the cam mechanism 40, the heart cam 41 is pushed out by the coupling end 35a of the operation-side rod 35, and the cam pin 43 located at the waiting position P1 moves to the first pushing position P2, and then moves to the holding position P3 by releasing the grip for the gripping portion 21. However, in this case, as illustrated in FIG. 11, since movement of the stopper 10 is restricted by the door frame of the vehicle, the coil spring 47 provided in the recessed portion 48 of the cam mechanism 40 contracts, so that a pushing force to the stopper 10 is absorbed.

As described above, by providing the door closing restriction device 100 according to the present embodiment on the door 1 of the vehicle, the user operates the door closing restriction device 100 to cause the stopper 10 to protrude from the door edge portion 3, so that even when the door 1 is to be closed, the stopper 10 interferes with the door frame of the vehicle, the door closing is restricted, and the door glass 2 is protected.

Here, in a vehicle including a door control device that electronically controls locking and unlocking of the door 1, a situation may occur in which the door control device is not in operation due to an update of a program, interruption of power supply from a vehicle power supply due to some circumstances, or the like.

Even in such a situation, when the door closing restriction device 100 is provided, the closing of the door 1 can be restricted, and therefore, particularly in a vehicle including the sashless door, it is possible to prevent damage to the door glass 2 caused by closing the door 1 in which the door glass 2 is in the closed state.

In addition, since the cam mechanism 40, which alternates, by operating the operation unit 20, between a pushing state in which the stopper 10 is caused to protrude and a retraction state in which the stopper 10 is retracted, is provided, a protrusion operation of the stopper 10 and a storage operation of the stopper 10 can be easily performed by operating the operation unit 20.

Next, a door closing restriction device 200 according to another embodiment will be described. The same components as those of the above-described door closing restriction device 100 are denoted by the same reference numerals, and the description thereof will be omitted.

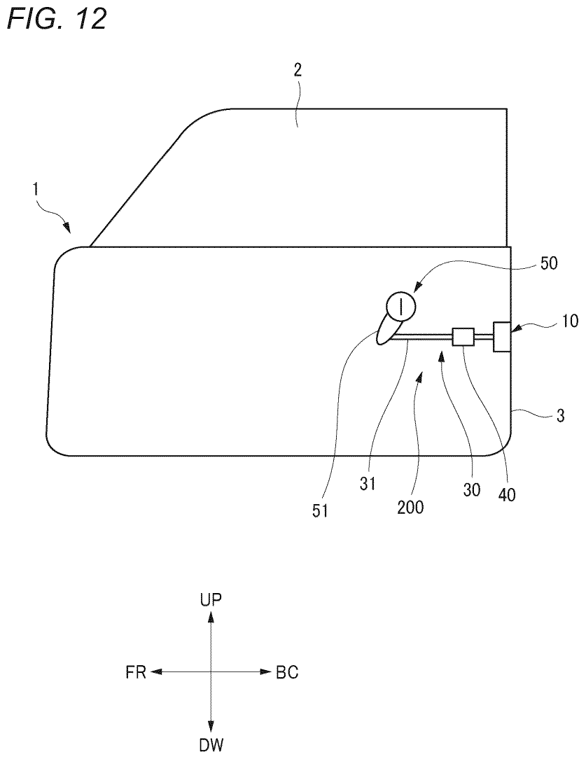

FIG. 12 is a schematic configuration diagram of the door 1 including the door closing restriction device 200 according to the another embodiment as viewed from the outside.

As illustrated in FIG. 12, the door closing restriction device 200 according to the another embodiment includes an operation unit 50 on an exterior panel of the door 1. The operation unit 50 has a cylinder, and can be operated by the user inserting a key into the operation unit 50 and rotating the key. In this way, the operation unit 50 can be operated from the outside of the door 1.

The operation unit 50 includes an arm 51, and the rod 31 of the transmission unit 30 is coupled to an end portion of the arm 51. Accordingly, in the door closing restriction device 200, by rotating the operation unit 50 by the key inserted by the user, the rod 31 of the transmission unit 30 is moved along a longitudinal direction, and the door closing restriction operation and the release of the door closing restriction of the door 1 are performed by the stopper 10. In this way, in the door closing restriction device 200, the door closing restriction operation and the release of the door closing restriction operation of the door 1 can be performed from the outside of the door 1.

The door closing restriction device 100 in which the operation unit 20 is provided inside the door 1 and the door closing restriction device 200 in which the operation unit 50 is provided outside the door 1 may be combined, and in this case, the door closing restriction operation and the release of the door closing restriction can be performed from the inside and the outside of the door 1.

In addition, as another embodiment, the above-described door closing restriction device may be provided on a door that can be electrically opened and closed by a switch or a sensor in a normal state.

In this case, the door 1 is configured as a door device of a vehicle including a raising and lowering device that raises and lowers the door glass 2 in the same manner as in the above-described embodiment, a door lock device that can hold the door 1 in a closed state, a door control unit that controls the raising and lowering device and the door lock device, a first operation unit that can transmit a control signal to the door control unit to cause the door lock device to release the holding in the closed state when a door opening operation for the door 1 performed by a user is received from a switch or a sensor in a normal state, a second operation unit that is mechanically coupled to the door lock device and mechanically releases the holding in the closed state performed by the door lock device when the door opening operation for the door 1 performed by the user is received in an emergency or the like, and a door closing restriction device that restricts the closing of the door 1. The door closing restriction device does not restrict the closing of the door 1 when an operation for the first operation unit is received, and restricts the closing of the door 1 when an operation for the second operation unit is received. The door closing restriction device may be the stopper 10 as in the above-described embodiment, and may be configured to restrict movement of a door driving portion in a door closing direction or to restrict movement in the door closing direction by a door check. The door control unit includes a processor, and a non-transitory computer-readable storage medium having a computer program stored thereon and readable by a computer.

Thus, the present disclosure is not limited to the above-described embodiments, and combinations of configurations of the embodiments, and changes and applications made by a person skilled in the art based on the description in the specification and well-known techniques are also intended by the present disclosure and included in the scope of protection.

As described above, the present specification discloses the following matters. [1] A door closing restriction device for restricting closing of a door of a vehicle, which is provided on the door, the door closing restriction device including:
a stopper provided to be retractable on a door edge portion of the door;
an operation unit provided on the door; and
a transmission unit configured to transmit an operation force of the operation unit to the stopper, in which
the stopper protrudes from the door edge portion by operating the operation unit.

According to the door closing restriction device in the above-described [1], when the operation unit is operated in a state in which the door is opened, the stopper protrudes from the door edge portion, and therefore, even when the door is to be closed, the stopper interferes with the door frame of the vehicle, the door closing is restricted, and the door glass is protected. Accordingly, in the vehicle including the sashless door, it is possible to prevent deterioration in the quality of the door glass caused by closing the door in which the door glass is in the closed state.

[2] The door closing restriction device according to [1], in which the transmission unit includes a cam mechanism configured to alternate, by operating the operation unit, between a pushing state in which the stopper is caused to protrude and a retraction state in which the stopper is retracted.

According to the door closing restriction device in the above-described [2], a protrusion operation of the stopper and a storage operation of the stopper can be easily performed by operating the operation unit.

[3] The door closing restriction device according to [1] or [2], in which the operation unit can be operated from at least one of the inside and the outside of the door.

According to the door closing restriction device in the above-described [3], by operating the operation unit from at least one of the inside and the outside of the door, the stopper can be caused to protrude from the door edge portion to restrict the closing of the door.

[4] A door device of a vehicle, including:
a door including a door glass and capable of being opened and closed with respect to a vehicle opening, the door glass being provided to be capable of being raised and lowered and being capable of being fitted to a weather strip provided at the vehicle opening at a highest position;
a raising and lowering device configured to raise and lower the door glass;
a door lock device capable of holding the door in a closed state;
a door control unit configured to control the raising and lowering device and the door lock device;
a first operation unit configured to transmit a control signal to the door control unit to cause the door lock device to release the holding in the closed state when a door opening operation for the door performed by a user is received;
a second operation unit mechanically coupled to the door lock device and configured to mechanically release the holding in the closed state performed by the door lock device when the door opening operation for the door performed by the user is received; and
a door closing restriction device configured to restrict closing of the door, in which
the door closing restriction device does not restrict the closing of the door when an operation for the first operation unit is received, and restricts the closing of the door when an operation for the second operation unit is received.

According to the door device in the above-described [4], in an electric door in which the door is opened and closed by the switch or the sensor at the normal state, since the door closing restriction device operates during an emergency operation (mechanical operation), it is possible to prevent the deterioration in the quality of the door glass caused by the user carelessly closing the door in which the door glass is in the closed state.

What is claimed is:

1. A door closing restriction device for restricting closing of a door of a vehicle, which is provided on the door, the door closing restriction device comprising:
a stopper provided on a door edge portion of the door and configured to be moveable between a storage position where the stopper is stored inside the door and a protruding position where the stopper protrudes from the door edge portion;
an operation unit provided on the door; and
a transmission unit configured to transmit an operation force of the operation unit to the stopper, wherein
the stopper moves to the protruding position by operating the operation unit.

2. The door closing restriction device according to claim 1, wherein
the transmission unit includes a cam mechanism configured to alternate, by operating the operation unit, between a pushing state in which the stopper is caused to protrude and a retraction state in which the stopper is retracted.

3. The door closing restriction device according to claim 1, wherein
the operation unit can be operated from at least one of the inside and the outside of the door.

4. The door closing restriction device according to claim 2, wherein
the operation unit can be operated from at least one of the inside and the outside of the door.

5. A door device of a vehicle, comprising:
a door including a door glass and capable of being opened and closed with respect to a vehicle opening, the door glass being provided to be capable of being raised and lowered and being capable of being fitted to a weather strip provided at the vehicle opening at a highest position;
a raising and lowering device configured to raise and lower the door glass;
a door lock device capable of holding the door in a closed state;
a door control unit configured to control the raising and lowering device and the door lock device;
a first operation unit configured to transmit a control signal to the door control unit to cause the door lock device to release the holding in the closed state when a door opening operation for the door performed by a user is received;
a second operation unit mechanically coupled to the door lock device and configured to mechanically release the holding in the closed state performed by the door lock device when the door opening operation for the door performed by the user is received; and
a door closing restriction device configured to restrict closing of the door, wherein
the door closing restriction device does not restrict the closing of the door when an operation for the first operation unit is received, and restricts the closing of the door when an operation for the second operation unit is received.
